(19) United States
(12) Patent Application Publication
(10) Pub. No.: US 2021/0161305 A1
(43) Pub. Date: Jun. 3, 2021

(54) FLUID FILLABLE SEAT CUSHION

(71) Applicant: Russell Drew LEDERMAN, Berlin, MD (US)

(72) Inventor: Russell Drew LEDERMAN, Berlin, MD (US)

(21) Appl. No.: 17/111,365

(22) Filed: Dec. 3, 2020

Related U.S. Application Data
(60) Provisional application No. 62/943,090, filed on Dec. 3, 2019.

(51) Int. Cl. A47C 27/08

(52) U.S. Cl. CPC A47C 27/085; A47C 27/088

(57) ABSTRACT

A fluid fillable cushioning device comprises an enclosure comprising a top wall and a bottom wall, a cavity defined by the enclosure, a threaded inlet in the enclosure connected to the cavity, the cavity further defined by the threaded inlet, and a fastening mechanism extending from the enclosure, the fastening mechanism configured to fasten the cushioning device to a seat. In operation, fluid, such as water, is filled in the cavity of the cushioning device, and in some cases foam is also included in the cavity, providing a water and/or foam cushion for a user sitting on the cushioning device. When used on seat of a bicycle, where the user's body interacts with the cushioning device with significant pressure for extended period of time, the cushioning device provides customizable cushioning which feels like an extension of the body, and is exceptionally comfortable.

### CROSS-REFERENCE TO RELATED APPLICATIONS

This application claims priority to the U.S. Provisional Application Ser. No 62/943,090, filed on Dec. 3, 2019, which is incorporated herein by reference in its entirety.

### BACKGROUND

### Field

This invention relates to cushion devices, and more particularly to a fluid refillable cushion device for a seat of vehicles.

### Background

Conventional seat cushion devices, for example, as available commercially, are either in a sealed gel-filled cushions, or made with solid cushion materials. However, such devices are fixed in their properties, and do not allow any configurability by a user of such cushion devices. Such cushion devices are also typically expensive to manufacture.

Moreover, the cushioning properties of such devices still do not alleviate the discomfort associated with sitting on seats, such as a bicycle seat, on which a user is seated and biking for long durations. Discomfort and injuries are common complaints for long distance and/or long duration bikers.

Accordingly, there exists a need in the art for an improved cushion device for seat of vehicles.

### SUMMARY

Embodiments described herein generally relate to a fluid fillable seat cushion, substantially as shown in and/or described in connection with at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF DRAWINGS

FIG. 1 is a perspective view of a fluid fillable cushioning device, according to an embodiment of the invention.

FIG. 2 is a cross sectional view of the fluid fillable cushioning device, according to an embodiment of the invention.

FIG. 3 is a cross sectional view of the fluid fillable cushioning device, according to an embodiment of the invention.

FIG. 4 is a perspective view of a fluid fillable cushioning device, according to an embodiment of the invention.

### DETAILED DESCRIPTION

Embodiments of the present invention overcome the drawbacks associated with conventional solutions by providing a fluid fillable cushioning device, in which the amount of fluid and other constituents can be custom-filled by the user. Such customizable seat cushioning devices enable a high level of comfort, and more effective in alleviating pain. The seat cushioning device includes a top wall for interfacing with a user, a bottom wall for interfacing with a seat, a seam at which the top wall and the bottom wall unite to form an enclosure, a cavity within the enclosure for receiving fluid, an opening formed in the enclosure to receive fluid and other material into the cavity, a leak proof threaded inlet at the opening, and a fastening mechanism, such as straps with fasteners or stretch-fit side walls to hold the device in stable position with respect to the seat. Water is filled in the cavity through the inlet, which is then sealed using a threaded cap with screws that mate with the threaded inlet. The cushioning device is made from flexible materials, such as natural or synthetic rubber, plastics, and the like, and may include additives to provide desirable properties, such as ultra-violet (UV) protection, better feel, strength, among others. When filled with water, the cushioning device has an elasticity and a touch and feel that is comfortable for a user. In some embodiments, the cushioning device further includes foam (sponge) material or other composite absorptive material located in the cavity. When filled with water, the foam or composite material imparts a more tactile cushion than with only water, achieving even higher comfort for the user. Varying the amount of water (or fluid) and the amount and quality of foam or composite material in the cavity allows a high-degree of customization of the feel of the cushioning device. For example, the fluid and foam combination is customizable to mimic the density and/or fluidity of a human body which contacts the cushioning device, such that the cushioning device feels like an extension of the human body.

In some embodiments, the cushioning device is shaped like a bicycle seat, that is, triangular shape. In some embodiments, the cushioning device has a rectangular shape. In some embodiments, the cushioning device is formed as a part of, or an appendage of a garment that is wearable by the user, such that the cushioning device lies between the user and the seat. The cushioning device disclosed herein can be shaped and configured for use in any vehicle seat, and provides comfort and reduces pain associated with sitting on seats for long duration of time.

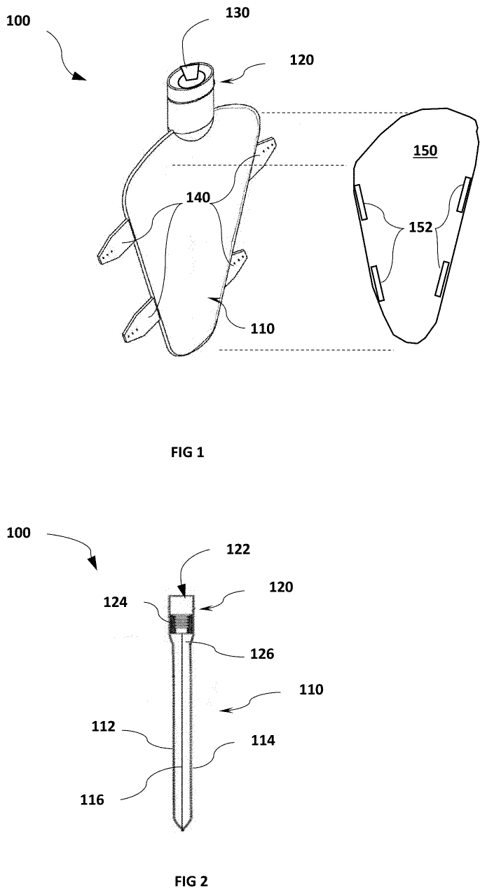

FIG. 1 is a perspective view of a fluid fillable cushioning device 100, according to an embodiment of the invention. In FIG. 1, the cushioning device 100 is shown in a triangular configuration, adapted to be affixed atop a bicycle seat. The cushioning device 100 includes a body or an enclosure 110, an inlet 120 defining an opening into the enclosure 110, and fastening mechanism 140 extending from the enclosure 110. The inlet 120 is a threaded inlet and configured to mate with a threaded cap 130, to seal the opening into the enclosure 110. In some embodiments, the fastening mechanism 140 includes straps 140 with holes therein, to allow for being looped around and fastened on a bicycle seat, for example, using fasteners such as nuts and bolts, rivets, pins, and the like. In some embodiments, cushioning device 100 is paired with a cover 150 on at least one side of the enclosure 110. The cover 150 is configured to stay attached to the enclosure 110, for example, by an adhesive bonding the cover 150 to a surface of the enclosure 110, or secured via slots 152 with the fastening mechanism 140, and/or another portion of the cushioning device 100. In some embodiments, the straps 140 are inserted through the slits 152 of the cover 150, and then looped around the bicycle seat and then fastened. In some embodiments, the cover 150 is configured to protect the cushioning device 110 from damage due to exposure to sunlight. In some embodiments, the cover 150 is also configured to provide a desired contact feel to the cushioning device 100. For the bicycle seat, the cushioning device 100 is shaped like an isosceles triangle, and the inlet is positioned to overlap with the rear of the bicycle seat, along the central line of symmetry, and on the center of the edge between symmetrical sides of the cushioning device 100.

FIG. 2 is a cross-sectional view of the cushioning device 100, according to an embodiment of the invention. The enclosure 110 has two walls, a bottom wall 112 and a top wall 114 connected at a center line 116. The center line 116 may be a seam at which the bottom and top walls 112, 114 are fused, or is an imaginary line for reference. The bottom wall 112 is configured to interface with a seat of a vehicle, and for the cushioning device 100, a seat of a bicycle. In some embodiments, the bottom wall 112 has a surface texture to enhance grip with the seat. The top wall 114 is configured to interface with a user or a sitter, that is, the rider of the vehicle or the bicycle. In some embodiments, the top wall 114 has a surface texture to enhance comfort and/or grip with the user's clothing. If a cover, for example, the cover 150 is applied to the top wall 114, the surface texture of the top wall 114 may be suitable for adhesion with the cover 150 (e.g., if an adhesive is used), or for enhancing grip with the cover 150 (e.g., if the cover 150 is secured via the slots 152). In some embodiments, the walls 112, 114 are identical. The inlet 120 comprises an opening 122, in which a threaded inlet 124 is affixed. The opening 122 extends through the threaded inlet 124 and connects to a cavity 126 internal to the enclosure 110. The cavity 126 is defined by the walls 112, 114 and the threaded inlet 124, and is configured to receive a fluid, such as water, and other solids, such as foam.

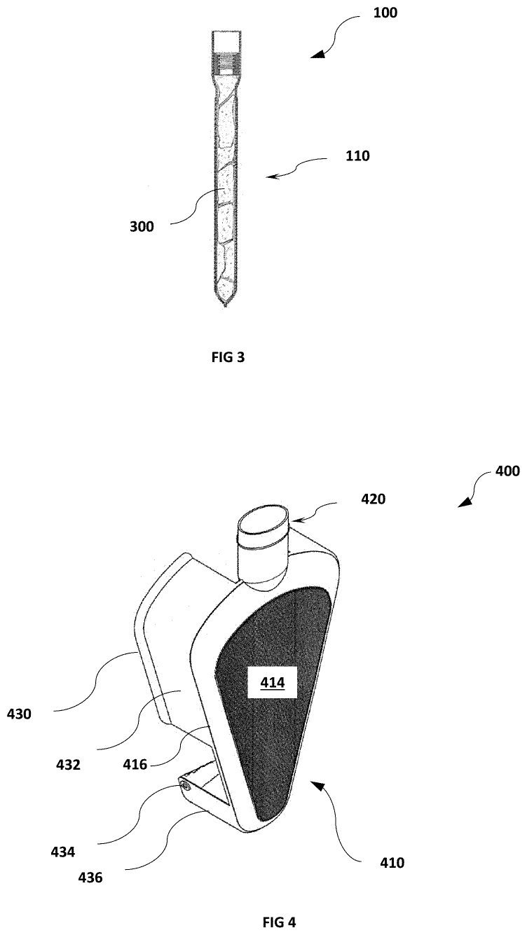

FIG. 3 shows a cross-section of the cushioning device 100 comprising foam material 300 inserted into the cavity 126, according to an embodiment of the invention. The foam 300 may be a single piece or multiple pieces, or multiple pieces of different density, pore size and the like. When water is poured into the cavity 126, and the cushioning device 100 is sealed by screwing the cap 130 to seal the cavity 126, at least part of the water is absorbed by the foam 300, and the cushioning device 100 provides a very comfortable cushioning effect to the user.

It is theorized that the water and foam combination, in the sealed cavity of the cushioning device 100 mimics or is similar to the feel of a human body interfacing with the cushioning device, thereby providing unmatched comfort. Further, by varying the amount of water, the type and amount of foam, the user can customize the cushioning effect of the cushioning device 100 to a very high degree, which leads to unmatched comfort for the user. Regardless of the accuracy of the theorization, experimental use of the device in several long-distance bike rides has shown unparalleled riding comfort and significantly reduced instance of injury of discomfort.

The fastening mechanism 140 of FIG. 1 shows straps 140 with holes, which straps go around the bicycle seat. For example, two straps from either side, proximate to the inlet 120 are stretched, bent around the bicycle seat such that a hole from each strap overlaps, and fastened by fasteners which go through the overlapping holes. Similarly, two straps from either side, distal to the inlet 120 are stretched and fastened around the bicycle seat. The straps 140 fasten the cushioning device 100 stably onto the bicycle seat, and keep the cushioning device 100 stably fastened during use, that is, when the user is biking while sitting on the cushioning device 100 on the bicycle seat. In some embodiments, instead of holes, the straps 140 include hook and loop fasteners. In such embodiments, the hook and loop fasteners may extend from flexible/extendable straps, or entire straps 140 may be hook and loop fasteners straps.

FIG. 4 is a perspective view of a fluid fillable cushioning device 400, according to an embodiment of the invention. The cushioning device 400 comprises an enclosure 410, similar to the enclosure 110, and an inlet 420, similar to the inlet 120. The enclosure comprises a bottom wall (not show in FIG. 4), a textured top wall 414 for enhanced grip, and a center line 416. The cushioning device 400 is similar to the cushioning device 100, except that instead of the fastening mechanism 140 of straps 140, the cushioning device 400 includes stretch-fit rear side wall 432 and stretch-fit front side wall 436, extending from a center line 416 of an enclosure 410, away from the top wall 414. The side wall 436 includes holes 434 on either side to allow a thread to engage the side wall 436 with the front of the bicycle seat. The side wall 432 includes an integral tubing 430 configured to receive a thread, which can be tightened and tied up to engage the side wall 432 with the rear portion of the bicycle seat. Together, engaging the side walls 432 and 436 secures the cushioning device 400 to the bicycle seat.

In some embodiments, the cavity of cushioning devices 100 (or 400) has a volume of about 5 cups, and in some embodiments, the cavity has a volume of about 1 cup. In some embodiments, when filled with water and/or foam, during use, the height of the cushioning devices when affixed to the seat is between about a ⅛^{th} of an inch to about 3 inches, and in some embodiments the height is between about ½ inch to about 1 inch. In some embodiments, pieces of foam having a dimension of 1″×1″×½″ are used, however, other sizes of foam may be used. In some embodiments, 1 to 100 pieces of such foam are inserted, and in some embodiments, 20-50 pieces of foam are inserted. In some embodiments, a single large piece of foam is used. Varying the number of foam pieces varies the foam-water density, which in turn varies the stability experienced by the user.

In some embodiments, the thickness of the bottom and/or top walls (e.g. walls 112, 114) is between about 1/64^{th} of an inch to about ⅛^{th} of an inch, and in some embodiments, the thickness is between about 1/32^{nd} of an inch to about 1/16^{th} of an inch. In some embodiments, one or both the walls are thicker in some regions than others, for example, front and/or back region of the cushioning device. In some embodiments, thickness of a band of about 1″ to about 3″ along the center line (e.g. the center line 116) is thicker than other regions. Such thicker profiles reinforce the structure and prevent ballooning of the cushioning device under pressure, and such reinforcement by thickening the walls can be provided along curved profiles, or other portions where ballooning is expected or observed. In some embodiments, the thickness of the straps (e.g. straps 140) is between about 1/64^{th} of an inch to about ¼^{th} of an inch, and in some embodiments, the thickness is between about 1/16^{th} of an inch to about ⅛^{th} of an inch.

In some embodiments, the cavity of the cushioning devices includes regions in which the top and the bottom walls are fused or affixed, preventing any water or foam therebetween. Such regions can be shaped to regulate the deformation of the regions in which water and/or foam is contained, according to the motion of the user, for example, while biking.

In some embodiments, the material of the cushioning device is resistant to degradation by exposure to sunlight and/or other weather elements. In some embodiments, the cushioning device may be made using natural rubber, synthetic rubber, polymeric material, additives for desired properties, or any combination thereof. Some of the polymers include, without limitation, neoprene, silicone, VITON, EPDM, SBR, Buna, among others. In some embodiments, the foam material includes a household sponge, as commonly available. In some embodiments, the inlet of the cushioning device may include an insert comprising a screw stopper arrangement made using metal and/or plastic. To avoid freezing of the water in cold season, a ⅓ ratio of isopropyl alcohol is added to prevent freezing. In hot weather, refrigerated cold water is used and warm water is used in the winters. The device provides a comfortable experience for the user as it allows the user to adjust the temperature of the water based on the weather. The device material is made of Neoprene, natural or synthetic rubber that provides similar feel as that of human tissue once the cavity is filled with water.

The present invention provides a fluid fillable cushioning device that provides cushioning to the vehicle seat. The invention allows to adjust the cushioning as desired by the user by adjusting the amount of water to be filled. The device provides comfort in case when the user is sitting on the vehicle for a long time and eliminates the pain that arises due to long drive. The device can be easily transported when it is not filled with water.

Various embodiments disclosed herein provide a cushion which is inexpensive and easy to manufacture from commonly available components, has a cavity which may be filled with a fluid such as water for providing enhanced support to a user seated on the cushion, such as cushion for seats of bicycle, bike, car or other vehicles.

It is to be understood, however, that even though numerous characteristics and advantages of the present invention have been set forth in the foregoing description, together with details of the structure and function of the invention, the disclosure is not restrictive to the techniques described herein. Changes may be made in the details, especially in matters of shape, size, and arrangement of parts within the principles of the invention to the full extent indicated by the broad general meaning of the terms in which the appended claims are expressed.

1. A fluid fillable cushioning device comprising:
an enclosure comprising a top wall and a bottom wall;
a cavity defined by the enclosure;
a threaded inlet in the enclosure connected to the cavity, the cavity further defined by the threaded inlet; and
a fastening mechanism extending from the enclosure, the fastening mechanism configured to fasten the cushioning device to a seat.

2. The device of claim 1, further comprising one or more pieces of foam in the cavity.

3. The device of claim 1, wherein the fluid is selected from the group comprising of water, alcohol, cold water and warm water.

4. The device of claim 1, wherein the cushioning device includes one or more of Neoprene, natural rubber, synthetic rubber or a ultra-violet (UV) resistant material.

5. The device of claim 1, wherein the fastening mechanism comprises a plurality of straps configured to lock underneath a seat on which the cushioning device is placed, securing the cushioning device to the seat.

6. The device of claim 5, wherein each of the straps comprises at least one hole which overlaps with the at least one hole of the opposing strap underneath the seat.

7. The device of claim 5, wherein the fastening mechanism is a hook and loop fastening mechanism, and opposing straps function as hook and loop, respectively.

8. The device of claim 1, wherein the fastening mechanism is a stretch-fit side wall extending from a center line between the top wall and the bottom wall, away from the top wall, the side wall comprising at least of holes or tubing to receive threads, the threads configured to tighten the side wall to a seat on which the cushioning device is placed, securing the cushioning device to the seat.

9. The device of claim 1, further comprising a threaded cap configured to engage with the threaded inlet, and configured to removably seal the cavity.
